(19) United States
(12) Patent Application Publication
(10) Pub. No.: US 2003/0135858 A1
(43) Pub. Date: Jul. 17, 2003

(54) Vehicle receiver and vehicle-mounted system

(76) Inventor: Hiroyuki Nemoto, Iwaki-city (JP)

Correspondence Address: BRINKS HOFER GILSON & LIONE, P.O. BOX 10395, CHICAGO, IL, 60611, US

(21) Appl. No.: 10/325,671

(22) Filed: Dec. 19, 2002

(30) Foreign Application Priority Data
Jan. 9, 2002 (JP) 2002-1889

(51) Int. Cl. H04H 7/00; H04N 7/18

(52) U.S. Cl. 725/75; 455/3.06

(57) ABSTRACT

A vehicle receiver and a vehicle-mounted system are provided for preventing battery exhaustion and for increasing the opportunity to update software. A vehicle receiver 100 is operable to download software by the use of a broadcast wave. The receiver includes a controller 5 which determines a reception state of the wave when the vehicle is parked and sets a downloading operation to a non-execution state when the reception state is not good. Thus, when the reception state of the broadcast wave is bad, the receiver is prevented from performing a wasteful downloading operation when the vehicle is parked.

### BACKGROUND OF THE INVENTION

1. Field of the Invention

The present invention relates to a vehicle receiver for receiving various types of digital broadcasts.

2. Description of the Related Art

In recent years, various types of broadcasts have been shifted from analog to digital form. For example, BS (Broadcasting Satellite) digital broadcast has already come into service, and CS (Communication Satellite) digital broadcast and a ground wave digital broadcast are also scheduled to begin. Generally, digital broadcast systems can utilize radio waves more effectively than known analog broadcast systems, thereby to permit multiplexing many channels in a broadcast wave of one frequency. These various types of digital broadcasts allow reception of a large number of channels compared with the known analog broadcasts, and hence the so-called multichannel broadcast applications are realized.

In the BS digital broadcast, software for control of the operation of a receiver is superimposed on the broadcast wave to be transmitted, thereby enabling an update of the software, that is, achieving the so-called downloading function. The receiver downloads the software superimposed on the broadcast wave, thereby facilitating update processing which amends and updates defects in the software therein, and the like. It is understood that this kind of updating system will be employed in other, future widespread digital broadcasts.

Furthermore, the receivers for the reception of various digital broadcasts have been developed not only for home use, but also for the use of mobile units such as a vehicle or the like. Especially, the use of a receiver in a mobile unit allows a user to enjoy the digital broadcasts of higher quality in comparison with the conventional analog broadcasts even while travelling in a vehicle or the like.

The digital receiver is designed to execute the downloading of the software when it does not receive every program according to predetermined scheduling. In the home-use digital receiver, the downloading is carried out when a power switch is turned off with a power code inserted in a socket for home use, which is a standby state. For instance, in a receiver that has been scheduled to update the software at midnight, the power switch is turned on just before the scheduled time, namely, midnight, by means of a timer function installed therein so as to get ready for the reception of the broadcast wave superimposed with the software. Subsequently, the updating of the software is executed in the standby state according to the scheduling.

In the vehicle-mounted digital receiver, however, as distinct from the home-use digital receiver, even the downloading in response to the scheduling often fails when the vehicle is parked in a bad place to receive the broadcast wave. For this reason, in cases where the vehicle has been parked for a long time in such a place, the downloading operation is repeatedly executed, undesirably leading to a dead battery. Also, in cases where the vehicle has been frequently driven in the middle of the night, the digital receiver possibly receives the broadcast waves at the time when the downloading is scheduled, disadvantageously resulting in decreasing the opportunity to download, namely, to update the software.

### SUMMARY OF THE INVENTION

The present invention has been accomplished in view of the above-mentioned technical background, and it is an object of the present invention to provide a vehicle receiver and a vehicle-mounted system for preventing battery exhaustion and for increasing the opportunity to update software.

To solve the foregoing problems, according to one aspect of the present invention, there is provided a vehicle receiver for downloading software by utilizing a broadcast wave. This vehicle receiver is prevented from downloading in a case where the receiver is not in a good reception state of the broadcast wave when the vehicle is parked. In detail, the vehicle receiver comprises a downloading processor for executing the downloading operation, a scheduling processor for scheduling the downloading operation such that the downloading processor executes the downloading operation at predetermined time, a reception-state determining section for determining the reception state of the broadcast wave, a first downloading setter operable to set the downloading operation of the downloading processor in a non-execution state if the receiver is not in the good reception state while parked, and a standby processor operable to set a component of the receiver which is required for reception of the broadcast wave to be in a standby state after the setting of the first downloading setter. Thus, in cases where the reception state of the broadcast wave is not good while the vehicle is parked, and execution of the downloading operation is not expected to normally terminate while at the parking place, the receiver is designed so as not to execute the downloading operation. This minimizes power consumption which may be caused by performing the undesired downloading operation, thereby preventing battery exhaustion while the vehicle is parked.

Preferably, the vehicle receiver may also comprise a key-state detector for detecting connection and disconnection states of a key switch of the vehicle. When the key-state detector detects the disconnection of the key switch, the aforesaid downloading setter may set the non-execution state based on the reception state determined by the reception-state determining section. Thus, by detecting the connection and disconnection states of the key switch, it is possible to precisely determine whether the vehicle is parked or not, thereby preventing the downloading operation that may be uselessly attempted while the vehicle is parked.

The aforesaid reception-state determining section may determine the reception state based on a reception level of an intermediate frequency signal corresponding to the broadcast wave. Alternatively, the aforesaid reception-state determining section may determine the reception state based on a bit error rate occurring after demodulation of data on the broadcast wave. These methods allow a precise determination or examination of the quality of the reception state.

Preferably, the vehicle receiver may also comprise a first informing section for giving predetermined notice of when the downloading setter sets the downloading operation in the non-execution state. If the receiver is determined to be in a bad reception state of the broadcast wave, there is provided a notice that the downloading operation cannot be executed. This allows a driver or the like, given this notice, to change a parking place or the like, thereby enabling the downloading operation to be normally terminated, thereby increasing the opportunity to update the software.

Preferably, the receiver may also comprise a second downloading setter operable to set the downloading operation of the downloading processor to the non-execution state in a case where the software is not normally available after the downloading operation is executed by the aforesaid downloading processor. Thus, when a downloading operation is not normally terminated, future downloading operations will not be performed. This minimizes wasteful power consumption in cases where the reception state of the broadcast wave is good upon parking but not good thereafter for some reason, thereby preventing battery exhaustion.

The aforesaid second downloading setter preferably performs the setting of the non-execution state based on a result of the downloading operation which is executed a plurality of times by the downloading processor. The non-execution state is set from the result of the plural-time downloading operation. Therefore, when one downloading operation has not been terminated normally due to unexpected reasons, future downloading operations thereafter will not be attempted. Preferably, the vehicle receiver may also comprise a second informing section for giving predetermined notice of when the aforesaid second downloading setter sets the downloading operation in the non-execution state. Thus, the notice is given that the downloading operation has not been performed when the vehicle is parked. This notice allows a driver or the like receiving it to prepare for the next downloading operation in response to the next scheduling and to take measures, for example planning acquisition of the software by other ways, thereby increasing the opportunity to update the software.

Preferably, the vehicle receiver may also comprise a flag setter for setting a predetermined abnormal-end flag when the downloading operation is set in the non-execution state by the second downloading setter, and the second informing section may give the notice when the abnormal-end flag is set with the receiver started up. When the downloading operation fails to normally end when the vehicle is parked, there is given the notice that the downloading operation was unsuccessful after an engine connected to the key switch of the vehicle starts up. Accordingly, this prevents the battery from running down, and informs the driver of the contents of the notice with certainty.

According to another aspect of the present invention, there is provided a vehicle receiver for downloading software by utilizing a broadcast wave, another vehicle-mounted device and the receiver itself being switchably selected as an output source, wherein, when the vehicle-mounted device is selected, the downloading operation is rendered valid. In detail, the vehicle receiver comprises a downloading processor for executing the downloading operation, a scheduling processor for scheduling the downloading operation such that the downloading processor executes the downloading operation at a predetermined time, a selected-state determining section for determining which one of the vehicle receiver and the other vehicle-mounted device is in a selected state, and a third downloading setter operable to make the downloading operation of the downloading processor valid when the other vehicle-mounted device is determined to be in the selected state by the selected-state determining section. Thus, when the other vehicle-mounted device is selected even while the vehicle receiver is receiving the broadcast wave, the downloading operation is carried out. Even if the vehicle is frequently used in the middle of the night, which is likely to be designated as the time for the downloading by the scheduling, this aspect of the invention increases the opportunity to update the software by downloading.

When switching to the vehicle receiver during the aforesaid downloading operation, the downloading operation may preferably take priority. This further increases the opportunity to update the software.

Preferably, the vehicle receiver may also comprise a third informing section for giving notice that the downloading operation is being executed when switching to the vehicle receiver during the aforesaid downloading operation. This can prevent the downloading operation from being stopped or interrupted due to the driver's inadvertent operation, thereby increasing the opportunity to update the software through the downloading.

Furthermore, the aforesaid downloading processor preferably stops the downloading operation when switching to the vehicle receiver is instructed again after being given the notice by the third informing section. When the repeated instruction to switch to the receiver is given by the user, the downloading operation is forcefully terminated. Accordingly, this enables the user to immediately view or listen to programs as urgent needs arise, to allow the processing or downloading operation that appropriately reflects driver's individual circumstances.

According to still another aspect of the present invention, a vehicle receiver downloads software by utilizing a broadcast wave, with another vehicle-mounted device and the receiver being switchably selected as an output source, wherein the downloading operation is accepted with the vehicle receiver selected, and then the vehicle receiver is switched to the vehicle-mounted device when the downloading operation starts. In detail, the vehicle receiver comprises a downloading processor for executing the downloading operation, a scheduling processor for scheduling the downloading operation such that the downloading processor executes the downloading operation a predetermined time, a fourth downloading setter operable to make the downloading operation of the downloading processor valid when the vehicle receiver is in a selected state, and a switchover instructing section operable to provide an instruction to switch from the vehicle receiver to another vehicle-mounted device when the downloading operation starts with the vehicle receiver selected. Thus, even when the vehicle receiver is selected, the downloading operation is forcefully executed in compliance with the scheduling, thereby increasing the opportunity to download the software as much as possible. Moreover, in cases where viewing or listening to the programs through the receiver is interrupted by the downloading operation, switching to the other vehicle-mounted device is performed so that sounds can be listened to or pictures can be viewed from the other vehicle-mounted device, thereby reducing wasteful spare time possibly occurring during the downloading operation.

The switchover instructing section may provide an instruction to switch from the other vehicle-mounted device to the vehicle receiver after the downloading operation is terminated. This minimizes the interruption of the reception of the program by the downloading operation.

According to a further aspect of the present invention, a vehicle receiver downloads software by utilizing a broadcast wave, wherein, if the downloading operation is executed a predetermined number of times, but not normally terminated, then notice of failure is given by sending an e-mail. In detail, the vehicle receiver comprises a downloading processor for executing the downloading operation, a scheduling processor for scheduling the downloading operation such that the downloading processor executes the downloading operation at a predetermined time, and a fourth informing section for giving notice of the failure by sending an e-mail when the downloading operation is executed a predetermined number of times by the downloading processor but not normally terminated. Thus, when the downloading by the use of the broadcast wave fails to obtain the updated software, the notice of the failure is given by an e-mail. This notice allows a driver or the like receiving it to prepare for the next downloading operation in response to the next scheduling and to take measures, for example planning acquisition of the software by other ways, thereby increasing the opportunity to update the software.

Preferably, the e-mail sent by the aforesaid fourth informing section includes a notice that the downloading operation has not normally terminated, a specific address where the updated software is available, and a message to designate this specific address so as to obtain the updated software. Thus, the software that was not available by the downloading operation can be directly obtained through other communications.

Preferably, the vehicle receiver may also comprise an updated-software transferring section for transferring to the vehicle receiver the updated software obtained by designating the specific address included in the aforesaid e-mail. Particularly, the updated-software transferring section may include a recording medium in which the updated software is recorded, and a readout section for reading the updated software from the recording medium. Thus, the updated software obtained by designating the specific address can be transferred to the vehicle receiver with certainty.

According to a still further aspect of the present invention, there is provided a vehicle-mounted system comprising a vehicle receiver for downloading software by utilizing a broadcast wave, and a navigation device having the functions of route search and route guidance. This vehicle receiver requests the navigation device to perform route guidance to a place where updated software is available when the downloading operation executed a predetermined number of times is not terminated normally. In detail, the vehicle receiver included in this vehicle-mounted system comprises a downloading processor for executing the downloading operation, a scheduling processor for scheduling the downloading operation such that the downloading processor executes the downloading operation at a predetermined time, and a request section operable to make a request to the navigation device for the route guidance when the downloading operation is unsuccessfully executed a predetermined number of times by the downloading processor. Additionally, the navigation device included in this vehicle-mounted system comprises a destination setter operable to set the place where the updated software is available as a destination for route search processing when the route guidance is requested. Also, the navigation device comprises a route search processor for performing the route search processing so as to search for a traveling route required for guiding a vehicle to the destination set by the destination setter, and a route guidance processor for guiding the vehicle to the destination along the traveling route obtained by the route search processing of the route search processor. If the downloading by the use of the broadcast wave fails to obtain the updated software, then the vehicle is guided to a place where the updated software is available. Simply by driving the vehicle along a guidance route, the updated software can be obtained, thereby increasing the opportunity to update the software.

### BRIEF DESCRIPTION OF THE DRAWINGS

FIG. 1 is a schematic diagram showing a configuration of a vehicle-mounted system including a receiver of one preferred embodiment according to the present invention.

FIG. 2 is a functional block diagram of a controller.

FIG. 3 is a diagram showing a detailed configuration of a navigation device.

FIG. 4 is a flowchart showing the operation of the receiver in cases where downloading is executed while the vehicle is parked.

FIG. 5 is a partial flowchart showing the operation of the receiver in cases where a downloading function is rendered invalid when the downloading operation is unsuccessful.

FIG. 6 is a partial flowchart showing the downloading operation of the receiver which provides a predetermined notice when the downloading operation is unsuccessful.

FIG. 7 is a flowchart showing the operation of the receiver which gives notice of failure when the downloading operation is unsuccessful.

FIG. 8 is a flowchart showing the operation of the receiver when the vehicle is not parked with a key switch turned on.

FIG. 9 is a flowchart showing an alternative example in cases where switching to the receiver is instructed during the downloading.

FIG. 10 is a flowchart of the operation of the receiver in cases where the downloading operation is forcefully carried out.

FIG. 11 is a flowchart of the operation of the receiver in cases where it gives notice of the failure of the downloading by sending an e-mail.

FIG. 12 is an exemplary e-mail sent by an informing processor.

FIG. 13 is a schematic diagram showing a method of obtaining the software by means of a personal computer or the like.

FIG. 14 is a flowchart showing the operation of the receiver in cases where the downloading has failed more than a predetermined number of times while the vehicle is parked.

FIG. 15 is a flowchart showing the operation of the receiver and the navigation device when performing route guidance to a place where the software is available.

### DETAILED DESCRIPTION OF THE PREFERRED EMBODIMENTS

Hereinafter a vehicle receiver of a preferred embodiment according to the present invention will be described in detail with reference to the accompanying drawings.

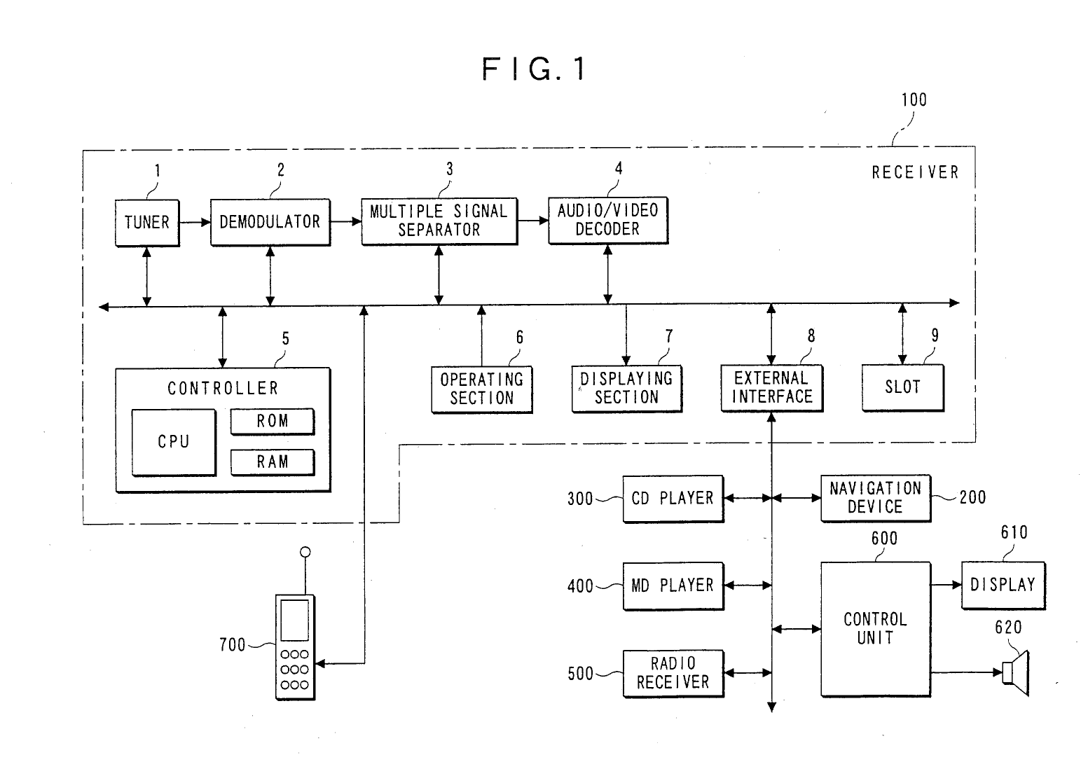

FIG. 1 shows a configuration of a vehicle-mounted system including a receiver of the preferred embodiment. The receiver 100 of the embodiment is a vehicle receiver mounted in a vehicle and receives digital broadcasts to reproduce pictures, sounds or the like. This receiver 100 is mutually connected to a navigation device 200, which is another vehicle-mounted device, a CD player 300, a MD player 400, a radio receiver 500, and a control unit 600, all of which form the vehicle-mounted system. Further, the receiver 100 of the embodiment has an Internet connecting function, and can access various web sites on the Internet, or send and receive e-mail by utilizing a mobile telephone 700 as a communication means.

The navigation device 200 performs navigating operations including the display of a map covering a present vehicle position and its surroundings, route guidance, and the like. The CD player 300 reproduces music recorded in a CD (compact disc). The MD player 400 reproduces music recorded in a MD (mini disc). The radio receiver 500 receives radio such as FM broadcast to output audio.

The control unit 600 controls the overall operation of the vehicle-mounted system, and performs display of the pictures or video, output of the sounds or audio. Concretely, the control unit 600 appropriately switches between a picture supplied from the receiver 100 and a map image supplied from the navigation device 200, to provide as an output the selected one to a display 610. Also, the control unit 600 properly switches between the sounds supplied from the receiver 100, the navigation device 200, the CD player 300, and the like, to provide as an output the selected sound to a speaker 620.

Next, the detailed configuration of the receiver 100 will be described below. The receiver 100 as shown in FIG. 1 includes a tuner 1, a demodulator 2, a multiple signal separator 3, an audio/video decoder 4, a controller 5, an operating section 6, a displaying section 7, an external interface (I/F) 8, and a slot 9.

The tuner 1 extracts a desired reception frequency component (tuning frequency) from a signal received via an antenna (not shown), and frequency-converts the extracted signal to provide an intermediate frequency signal. The demodulator 2 converts the signal supplied from the tuner 1 into digital data and thereafter performs demodulation processing in response to a broadcast type of the digital broadcast. The multiple signal separator 3 separates predetermined control information multiplexed into received data which is returned to the form of original data columns, and program data associated with a desired program, to output them separately. The audio/video decoder 4 decodes video data, audio data and the like, based on the program data separated by the multiple signal separator 3.

The controller 5 is used to control each part of the receiver 100 in response to operating instructions given by the operating section 6 so as to control the overall operation of the receiver 100, including channel selection processing, display processing of every operating screen, and the like. This controller 5 is configured as a computer including a CPU, a ROM, a RAM and so on, and performs control operation by executing predetermined software (program) stored in the ROM or RAM. The operating section 6 has various operating keys used for the channel selection or the like. The displaying section 7 displays an operating state of the receiver 100, for example a channel number of a channel being received.

The external interface 8 is used to transmit and receive data between the receiver 100 and external devices such as the navigation device 200. The slot 9 is used to hold a memory card which serves as an attachable and detachable recording medium so as to input and output the data.

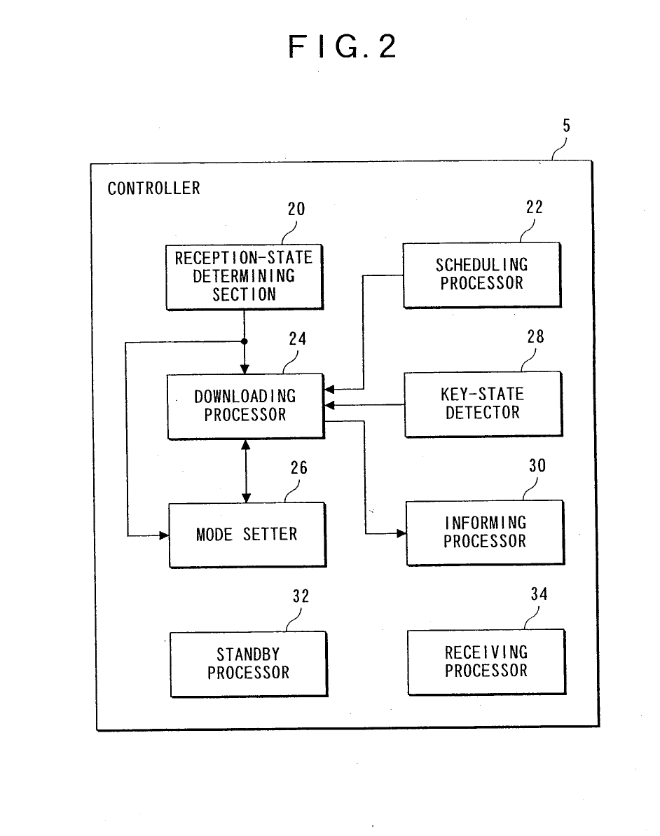

FIG. 2 shows a functional block diagram of the controller 5. Referring to FIG. 2, the controller 5 includes a reception-state determining section 20, a scheduling processor 22, a downloading processor 24, a mode setter 26, a key-state detector 28, an informing processor 30, a standby processor 32, and a receiving processor 34.

The reception-state determining section 20 determines a reception state of a broadcast wave. The reception state of the broadcast wave is determined, for example, based on a signal level of an intermediate frequency signal corresponding to the broadcast wave, or based on the check on an error rate, namely, a bit error rate of the digital data into which the received broadcast wave is converted.

The scheduling processor 22 performs predetermined scheduling processing, that is, it manages an execution schedule of downloading processing and gives notice to the downloading processor 24 at a predetermined execution timing so as to have the downloading processing executed. The downloading processor 24 obtains or downloads the software transmitted through the use of the broadcast wave, thus updating the software to be executed by the controller 5.

The mode setter 26 sets various operation modes (operation types) of the downloading when the downloading operation is about to be executed under control of the downloading processor 24. These operation modes are, for example, “downloading execution mode” indicating that the downloading operation is valid, and “downloading cancellation mode” indicating that the downloading operation is invalid. In the downloading execution mode, there are a few operation modes, for example, “forced execution mode” indicating that the downloading operation is forcefully executed even while receiving various program data, “normal execution mode” indicating that the downloading operation is executed in a standby state where the program data is not being received.

The key-state detector 28 detects the connection and disconnection states of a key switch of the vehicle with the receiver 100 mounted thereon. The informing processor 30 informs a user when the downloading operation is unsuccessful. In detail, the informing processor 30 generates a predetermined informing image, namely, informing image data to send to the control unit 600, and then causes the display 610 connected to the control unit 600 to display the informing image, thus giving notice of the failure. It is noted that the informing processor may generate a predetermined informing voice, namely, informing voice data to send to the control unit 600, and then cause a speaker 620 connected to the control unit 600 to output the informing voice, thus giving notice of the failure.

The standby processor 32, after an ignition key is operated to turn the key switch off, halts various functions of parts of the receiver 100 which are required for the reception of the broadcast wave, to set them in a standby state. The receiving processor 34 controls the parts such as the tuner 1, the demodulator 2, and the like, so as to receive the broadcast wave to produce the sounds or the pictures.

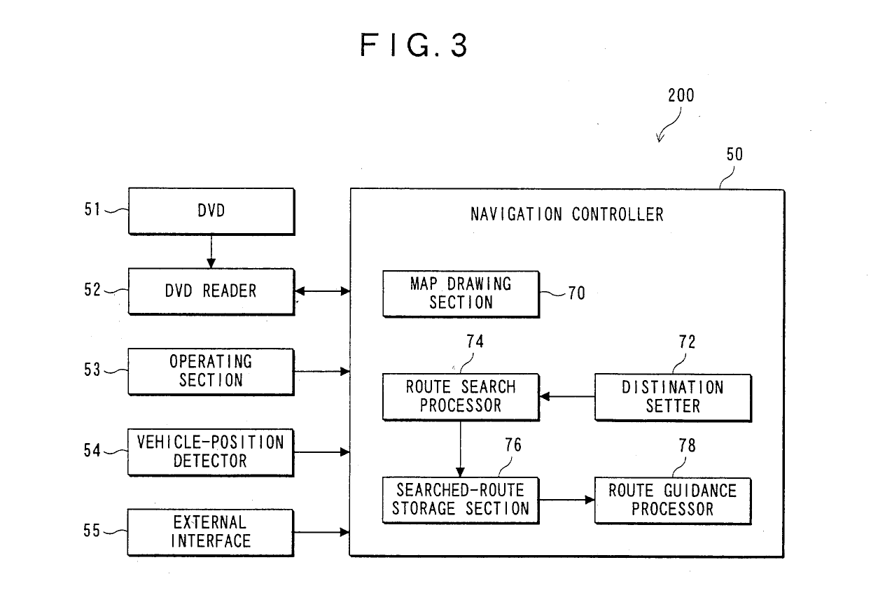

Now, the detailed configuration of the navigation device 200 will be described. FIG. 3 shows the detailed configuration of the navigation device 200. The navigation device 200 as shown in FIG. 3 includes a navigation controller 50, a DVD (digital versatile disc) 51, a DVD reader 52, an operating section 53, a vehicle-position detector 54, and an external interface (IF) 55.

The navigation controller 50 controls the operation of the navigation device 200. This navigation controller 50 has its function achieved by executing predetermined programs through the use of a CPU, a ROM, a RAM, and the like provided therein. The detailed configuration of the navigation controller 50 will be described later.

The DVD 51 is a recording medium that stores map data required for map display, a route search, and the like. The DVD reader 52 has one or more of the DVDs 51 loaded, and reads out the map data from any one of the DVDs 51 under the control of the navigation controller 50.

The operating section 53 has various kinds of operating keys such as a joy stick for designating the vertical and horizontal directions, a ten-digit keypad, and a determination key for determining various settings. This operating section 53 generates a signal responsive to an operating instruction provided by the operating key to the navigation controller 50.

The vehicle-position detector 54 has, for example, a global positioning system (GPS) receiver, an angle sensor, a range sensor, and the like. It detects the present vehicle position (longitude, latitude) at a predetermined timing to produce a detected result. The external interface 55 is used for the navigation device 200 to transmit and receive the data to and from the external device such as the receiver 100.

Next, the detailed configuration of the navigation controller 50 will be described. Referring now to FIG. 3, the navigation controller 50 includes a map drawing section 70, a destination setter 72, a route search processor 74, a searched-route storage section 76, and a route guidance processor 78.

The map drawing section 70 creates map drawing data for displaying the map image based on the map data read from the DVD 51. The destination setter 72 searches for a facility (for example, an automotive supply shop) where the software of interest to be downloaded is available, and then sets the found facility as a destination for route search processing. The route search processor 74 searches for a traveling route connecting a predetermined starting point and the set destination at optimum cost. The searched-route storage section 76 stores route data for designating the traveling route obtained by the route search of the route search processor 74. The route guidance processor 78 reads out the route data stored in the searched-route storage section 76 to provide drawing data for displaying the traveling route of interest for guidance superimposed on the map, thus performing route guidance processing.

The aforesaid reception-state determining section 20 corresponds to a reception-state determining section in the appended claims; the scheduling processor 22 to a scheduling processor; the downloading processor 24 to a downloading processor; the mode setter 26 to first through fourth downloading setters; the key-state detector 28 to a key-state detector; the informing processor 30 to first through fourth informing sections; and the standby processor 32 to a standby processor, respectively. Similarly, the downloading processor 24 corresponds to a flag setter; the mode setter 26 to a selected-state determining section; and the receiving processor 34 to a switchover instructing section, respectively. Furthermore, the slot 9 corresponds to a readout section; a memory card 810 described later to a recording medium; and the slot 9 and the memory card 810 to an updated-software transferring section, respectively. In addition, the downloading processor 24 corresponds to a request section; the destination setter 72 to a destination setter; the route search processor 74 to a route search processor; and the route guidance processor 78 to a route guidance processor, respectively.

The receiver 100 of the preferred embodiment has the above-mentioned configuration. Now, the operation of the receiver will be described hereinafter.

### EXAMPLE 1

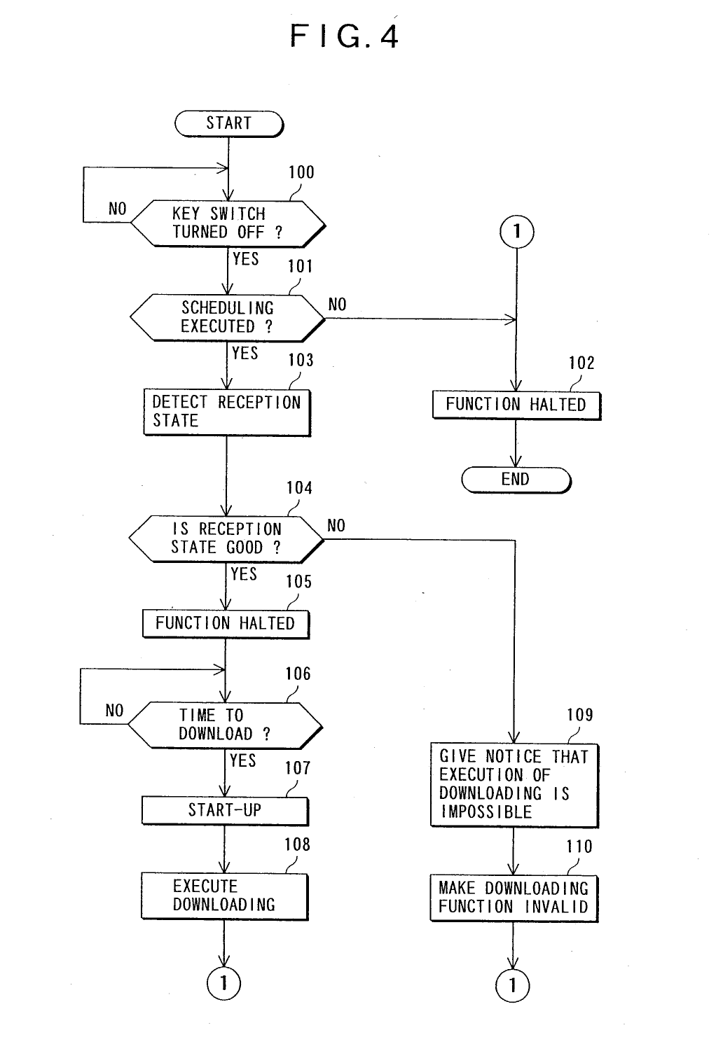

FIG. 4 shows a flowchart of the operation of the receiver 100 when the downloading is executed while the vehicle is parked.

The key-state detector 28 determines whether the key switch of the vehicle is turned off or not (step 100). While the key switch is not turned off, a negative determination is made, and the determination processing in the step 100 is repeatedly executed.

When the key switch is turned off, an affirmative determination is made in the step 100. Thereafter the scheduling processor 22 determines whether or not execution of the downloading is scheduled at a predetermined time (step 101). If it is not scheduled, a negative determination is made in the step 101, and the controller 5 halts the function of the receiver 100 (step 102).

If it is scheduled, an affirmative determination is made in the step 101. Then the reception-state determining section 20 detects the reception state of the broadcast wave (step 103), and successively determines whether the reception state is good or not (step 104). If the reception state is good, an affirmative determination is made, and the controller 5 halts or terminates the function of the receiver 100 (step 105).

Thereafter, the scheduling processor 22 determines whether or not it is time to download (step 106). If it is not time to download yet, a negative determination is made, and the determination processing in the step 106 is repeatedly performed.

If it is time to download, an affirmative determination is made in the step 106, and the controller 5 starts up the receiver 100 (step 107). At this time, at least the parts necessary for the execution of the downloading may be started up. Then the downloading processor 24 executes the downloading operation (step 108). When the downloading operation is terminated, the receiver 100 returns to the above step 102, to have its function halted by the controller 5.

On the other hand, when the receiver is not in a good reception state with the key switch turned off, a negative determination is made in the above step 104, and the informing processor 30 gives notice that the downloading operation is impossible to execute in the reception state at the present parking place (step 109). For instance, the informing processor 30 generates the predetermined informing image to send to the control unit 600, and thus causes the display 610 connected to the control unit 600 display the informing image.

The mode setter 26 sets the operation mode of the receiver to the downloading cancellation mode so as to render the downloading function invalid (step 110). Finally, the operation proceeds to the above-mentioned step 102, so that the receiver 100 has its function halted by the controller 5.

Thus, in cases where the execution of the downloading operation is not expected to normally terminate at a parking place where the reception state of the broadcast wave is not good, the receiver is prevented from executing the downloading operation. This minimizes power consumption which may be caused by performing the undesired downloading operation, thereby preventing battery exhaustion.

In cases where the receiver is determined to be in a bad reception state of the broadcast wave, there is provided the notice that the downloading operation cannot be executed. This allows a driver or the like given this notice to change the parking place, thereby enabling the downloading operation to be normally terminated, thereby increasing the opportunity to update the software of the receiver 100.

### EXAMPLE 2

In the above-mentioned embodiment, when the reception state upon parking is judged good, the downloading operation is performed according to the scheduling. For this reason, suppose the reception state is good when the key switch is turned off, and then the reception state becomes worse, resulting in the failure of the normal downloading operation. For example, the following cases are assumed: the reception state of the broadcast wave becomes bad because the vehicle is conveyed or carried with cargo in a container thereof, or because its door is closed after parking. In such cases, there is the possibility that the downloading operation is performed a plurality of times in compliance with the scheduling, resulting in wasteful power consumption. To eliminate this kind of inconvenience, when the downloading operation is executed one time (or a predetermined number of times) and not normally terminated, thereafter future downloading operation may not be carried out any more. In this case, the number of times of the downloading operation is not limited to one, but may be two or more. That is, after the downloading operation is executed two or more times, the downloading function may be rendered invalid, so that a future downloading operation will not be carried out.

FIG. 5 shows a partial flowchart of the operation of the receiver 100 in cases where the downloading function is set invalid when a one-time downloading operation ends in failure. The processing as illustrated in FIG. 5 is added to the above-mentioned step 108 as shown in FIG. 4.

After the downloading processor 24 executes the downloading operation (step 108), the mode setter 26 determines whether the downloading operation ended normally or not (step 120). If the downloading operation is not normally terminated, a negative determination is made, and the mode setter 26 sets the operation mode of the receiver to the downloading cancellation mode so as to make the downloading function invalid (step 121).

Thus, after the downloading cancellation mode is set, or after the downloading operation normally ends with an affirmative determination made in step 120, the operation of the receiver proceeds to step 102 of FIG. 4, whereby the function of the receiver 100 is halted by the controller 5.

As described above, when the downloading operation is repeatedly executed the predetermined number of times unsuccessfully, a future downloading operation will not be carried out, thereby cutting down on useless power consumption and preventing the battery from going dead.

### EXAMPLE 3

In the above-mentioned embodiment, when the receiver is determined to be in the bad reception state while the vehicle is parked, the notice that the downloading operation is impossible to execute is given to the driver or the like. However, in cases where the downloading operation is performed in step 108 of FIG. 4 only to be unsuccessful, another notice that the downloading operation was not executed may also be given to the driver or the like.

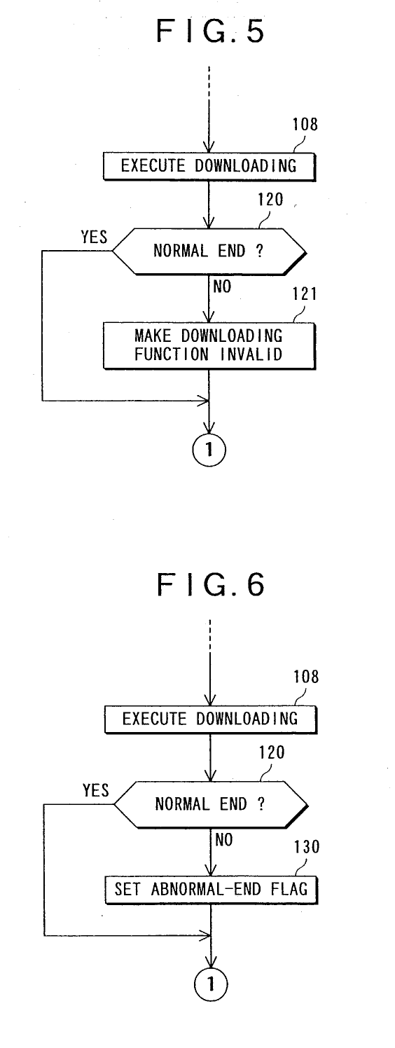

FIG. 6 shows a partial flowchart of the downloading operation of the receiver 100 which is designed to give a predetermined notice when the downloading operation is unsuccessful. The processing as illustrated in FIG. 6 is added to the above-mentioned step 108 of FIG. 4.

The downloading processor 24 executes the downloading operation (step 108), and then determines whether the downloading operation ended normally or not (step 120). If the downloading operation is not normally terminated, a negative determination is made, and the downloading processor 24 sets an abnormal-end flag indicating that the downloading operation has not been terminated normally (step 130). This abnormal-end flag may be set not only when one downloading operation is not terminated normally, but when downloading operations are performed two or more predetermined times unsuccessfully.

Thus, after the abnormal-end flag is set, or after the downloading operation is normally terminated and an affirmative determination is made in step 120, the receiver 100 proceeds to step 102 of FIG. 4, and finally the receiver 100 has its function halted by the controller 5.

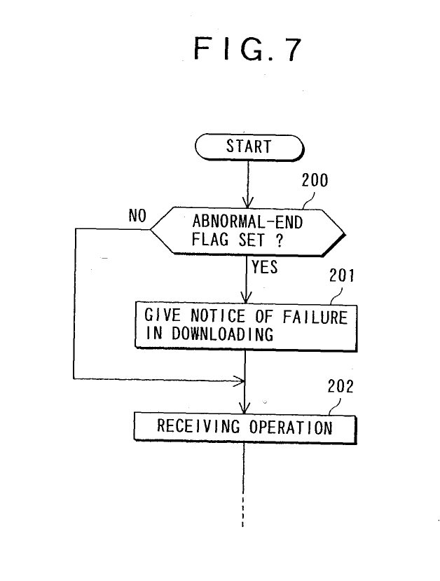

FIG. 7 is a flowchart showing the operation of the receiver 100 giving notice of failure when the downloading operation ends in failure.

The ignition key is operated by the driver to turn the key switch on, and then the power of the receiver 100 is turned on. Subsequently, the informing processor 30 determines whether the abnormal-end flag is set or not (step 200). If the abnormal-end flag is set, an affirmative determination is made, and the informing processor 30 gives notice that the downloading operation has ended in failure (step 201). For instance, the informing processor 30 generates a predetermined informing image to send to the control unit 600, and causes the display 610 connected to the control unit 600 display the informing image.

Subsequently, after the failure of the downloading operation is noted, or after a negative determination is made in step 200 because the abnormal-end flag is not set, the normal receiving operation is performed under the control of the controller 5 (step 202).

Thus, in cases where the downloading operation unfortunately is not normally terminated, a notice of the failure is provided. This notice allows a driver or the like receiving it to prepare for the next downloading operation in response to the scheduling and to take appropriate measures, for instance planning acquisition of the software by other ways (whose examples will be described later in more detail), thereby increasing the opportunity to update the software by the receiver 100.

### EXAMPLE 4

In the embodiments described above, the downloading operation occurs while the vehicle is parked. However, hereinafter the downloading operation will be described in detail when the vehicle is not parked with the key switch turned on. It should be noted that “when the vehicle is not parked” includes both cases of when the vehicle is traveling, and when the vehicle is stopped with the key switch turned on.

A receiver for home use, when its power switch is turned on, is designed to receive a user's desired broadcast wave. At this time, even though the downloading is scheduled, the home-use receiver does not execute the downloading operation. On the other hand, the vehicle receiver 100 with the power switch turned on often has the output of the sounds and/or display of the pictures from the receiver 100 itself rendered invalid because another vehicle-mounted device such as the CD player 300 is selected as an output source. In such cases, even if the downloading operation is executed according to the scheduling with the power switch of the receiver 100 turned on, no inconvenience occurs that interrupts viewing and listening to broadcast programs. Therefore, in the vehicle receiver 100, if the output of the sounds from the other audio source is rendered valid with the power switch of the receiver turned on, the downloading operation should be performed.

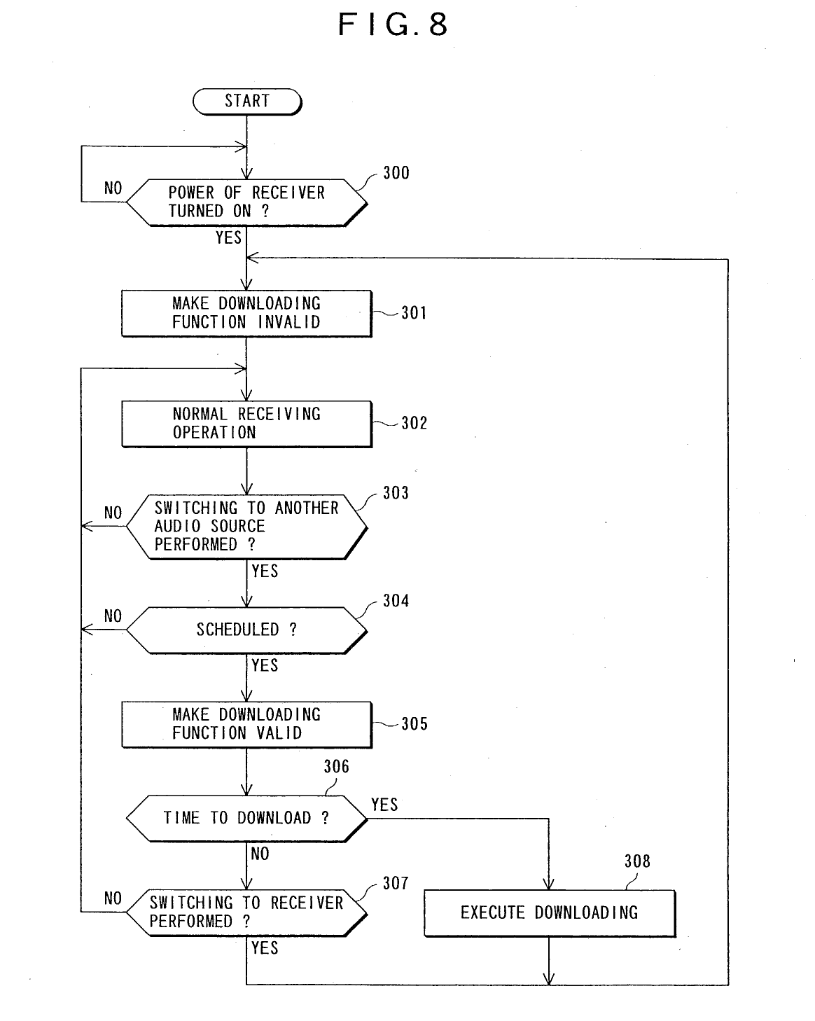

FIG. 8 shows a flowchart of the operation of the receiver 100 when the vehicle is not parked with the key switch turned on.

The receiving processor 34 determines whether or not the operating section 6 is operated (for example, the power switch is pushed down) to turn on the power of the receiver 100 (step 300). While the power is not being turned on, a negative determination is made, and the determination processing in step 300 is performed repeatedly.

If the power is turned on, an affirmative determination is made in step 300. Then the mode setter 26 sets the operation mode of the receiver to the “normal execution mode” to make the downloading function invalid during reception of the program data (step 301). Thereafter, the receiving processor 34 controls the parts of the receiver such as the tuner 1 and the like to perform the normal receiving operation (step 302). The mode setter 26 also observes the operation of the control unit 600 to determine whether or not the switching operation of the control unit 600 is performed by a user's instruction that switches the audio source of the sound output or the video display from the receiver to another audio source (for example, the CD player 300) (step 303). This switching operation is carried out, for example, by operating a switch (not shown) disposed in the control unit 600.

If the switching operation of the audio source is not performed while the sounds of the receiver 100 are being produced from the speaker 620 connected to the control unit 600, a negative determination is made in step 303. Then the operation returns to the above-mentioned step 302, so that the normal receiving operation is performed repeatedly.

If the switching operation of the audio source is performed, an affirmative determination is made in step 303. Then the mode setter 26 determines whether or not the scheduling processor 22 has scheduled the execution of the downloading operation (step 304). If the scheduling has not been made yet, a negative determination is made, and the operation returns to the above-mentioned step 302, so that the normal receiving operation is performed repeatedly. If the scheduling has already been made, an affirmative determination is made in step 304. Then the mode setter 26 sets the operation mode of the receiver to the “forced execution mode” to make the downloading function valid during reception of the program data from the other source (step 305).

Next, the scheduling processor 22 checks whether it is time to download (step 306). If it is not time to download yet, a negative determination is made. Then the mode setter 26 observes the operation of the control unit 600 to determine whether another switching operation of the control unit 600 has been performed by a user's instruction that switches the source of the sound output or the video display to the receiver 100 (step 307). If the switching operation to the receiver 100 has not been carried out yet, a negative determination is made, and the operation returns to the above-mentioned step 302 to repeat the normal reception of the broadcast wave. On the other hand, if the switching operation to the receiver 100 has been performed, an affirmative determination is made in step 307, and the operation returns to the above-mentioned step 301, so that the operation mode is set to the “normal execution mode”, and thereafter the normal receiving operation (step 302) is repeated.

Furthermore, if it is time to download, an affirmative determination is made in step 306. Then the downloading processor 24 executes the downloading operation (step 308). Subsequently, the operation returns to the above-mentioned step 301, and the operation mode of the receiver is set to the “normal execution mode” to thereafter repeat the normal receiving operation (step 302).

Thus, if the other vehicle-mounted device is selected even while the vehicle receiver 100 is in the receiving operation with its power turned on, the downloading operation is carried out according to the scheduling. Particularly for a vehicle frequently used in the middle of the night, which is likely to be designated as the time for the scheduled downloading, this increases the opportunity to update the software by the downloading.

As described above, when the downloading operation is started while the sound output from the other audio source is selected, there is a possibility that the sound output from the receiver 100 is selected again before the downloading operation is terminated. In this case, the downloading operation should not be unconditionally stopped to be switched to the reception of the program data, but should be continued.

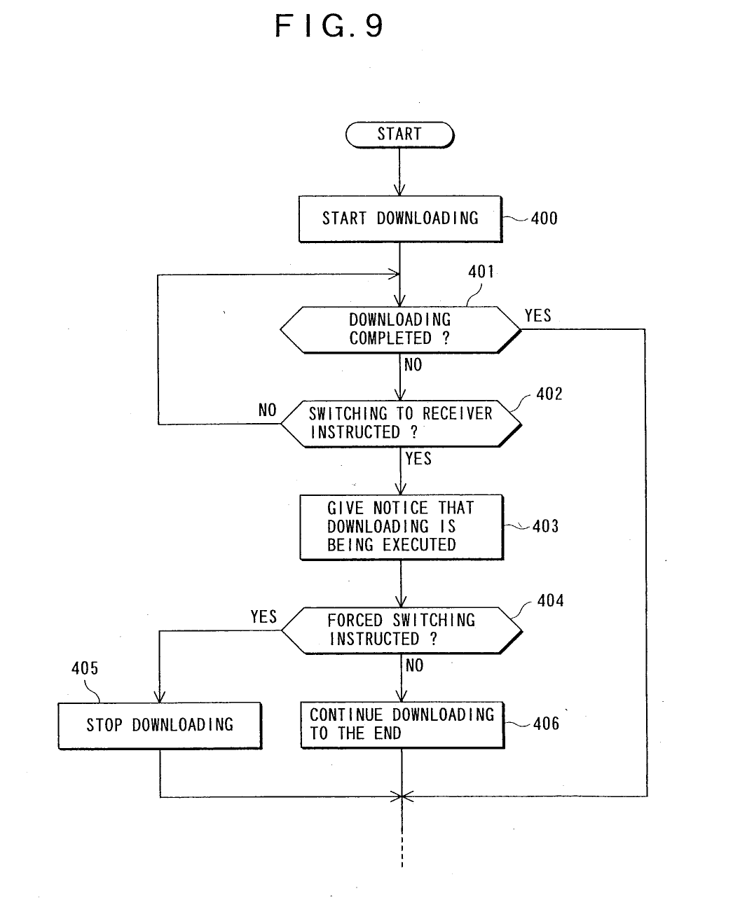

FIG. 9 is a flowchart illustrating an alternative example in cases where switching to the receiver 100 is instructed during the downloading operation. FIG. 9 shows the details of the downloading operation in step 308 of FIG. 8.

The downloading processor 24 starts the downloading operation (step 400), and thereafter determines whether or not this downloading operation is terminated (step 401), and whether or not switching to the receiver 100 is instructed (step 402). If switching to the receiver 100 is not instructed, a negative determination is made in step 402, and the steps beginning with step 401 in which termination of the downloading operation is determined, are performed repeatedly. In this state, when the downloading operation is terminated, an affirmative determination is made in step 401, and the steps beginning with step 301 of FIG. 8 are performed repeatedly.

If switching to the receiver 100 is instructed during the downloading operation, an affirmative determination is made in step 402. Then the informing processor 30 gives notice to the driver that the downloading operation is being executed (step 403). For instance, the informing processor 30 generates a prescribed informing image to send to the control unit 600, and causes the display 610 connected to the control unit 600 to display the informing image.

Next, the downloading processor 24 determines whether or not forced switching is instructed by the driver (step 404). Concretely, if a switch button installed in the control unit 600 for instructing the switching to the receiver 100 is pushed down twice, the downloading processor 24 determines that the forced switching is instructed. When such an instruction is given, an affirmative determination is made in step 404. Thereafter, the downloading processor 24 stops the downloading operation (step 405). If the forced switching is not instructed, a negative determination is made in step 404, and the downloading processor 24 continues executing the downloading operation to the end (step 406).

As described above, in cases where switching to the receiver 100 is instructed during the execution of the downloading operation, a notice that the downloading is being executed is given to the driver. This can prevent the downloading operation from being stopped or interrupted due to inadvertent operation of the driver, thereby increasing the opportunity to update the software through the downloading. Also, since the downloading operation can be forcefully terminated by the driver's specific operation, the receiver enables the user to immediately view or listen to the programs as urgent needs arise, thus allowing the processing or downloading operation that appropriately reflects the driver's individual circumstances.

In the described example, when switching to the receiver 100 is instructed during the downloading operation, a check is made to determine whether the forced switching is instructed by the driver or not. Alternatively, when the operation mode of the receiver is set to the “forced execution mode”, the downloading operation may take priority at all times. In this case, after giving the notice in step 403 as shown in FIG. 9, the determination processing in step 404 may be skipped, and subsequently the processing in step 406 may be performed, so that the downloading operation is carried out to the end.

### EXAMPLE 5

In the example of FIG. 8, when another audio source is selected with the power of the receiver 100 turned on, the downloading operation is executed. Alternatively, the update of the software by the downloading may take precedence over the receiving operation of the receiver 100.

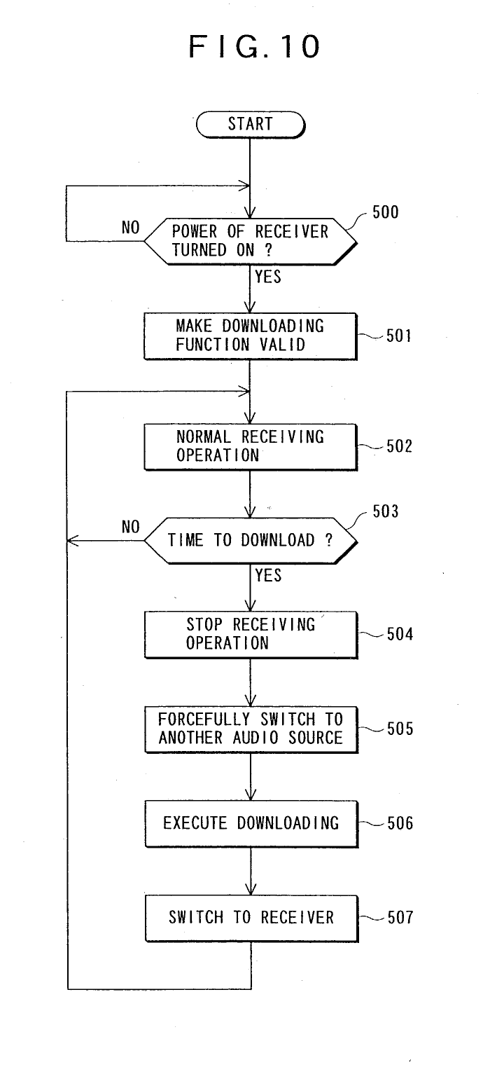

FIG. 10 shows a flowchart of the operation of the receiver 100 in cases where the downloading operation is forcefully carried out.

The receiving processor 34 determines whether or not the operating section 6 is operated to turn on the power of the receiver 100 (step 500). Until the power is turned on, a negative determination is made and the determination processing in the step 500 is performed repeatedly.

If the power is turned on with an affirmative determination made in the step 500, the mode setter 26 sets the operation mode of the receiver to the “forced execution mode” to make the downloading function valid while receiving the program data (step 501). Thereafter, the receiving processor 34 controls the parts of the receiver including the tuner 1, to perform the normal receiving operation (step 502).

Next, the downloading processor 24 determines whether or not it is time to download with reference to the scheduling (step 503). If it is not time to download, a negative determination is made, and the operation returns to the step 502 so that the normal receiving operation is repeated.

If it is time to download, an affirmative determination is made in step 503. Then the receiving processor 34 stops the receiving operation (step 504), and switches its selected state to the other audio source (step 505). In this example, the switching to the other audio source is not performed by the controller 5 in the receiver 100 (alternatively, the controller 5 may conduct this switching operation). By transmitting the predetermined switching instruction to the control unit 600, this switching operation is achieved. Thereafter, the downloading processor 24 executes the downloading operation (step 506). When this downloading operation ends, the switching to the receiver 100 is again performed (step 507), and subsequently the operation returns to step 502 so that the normal receiving operation is repeatedly carried out.

Accordingly, even if the receiver 100 is selected as the source of the sound output or the video display from the control unit 600, the downloading operation is forcefully executed in compliance with the scheduling, thereby increasing the opportunity to update the software by the downloading as much as possible.

### EXAMPLE 6

In the above-mentioned examples, the updated software transmitted by the broadcast wave is obtained by the downloading operation. However, when such a downloading operation ends in failure, methods other than the downloading may be employed to obtain the updated software.

However, when the downloading operation executed a predetermined number of times ends in failure, an e-mail can be sent that indicates not only the failure, but an address for acquisition of the updated software. From a specific site designated by this address for the acquisition, the user (or the driver) of the receiver 100 can freely obtain the updated software.

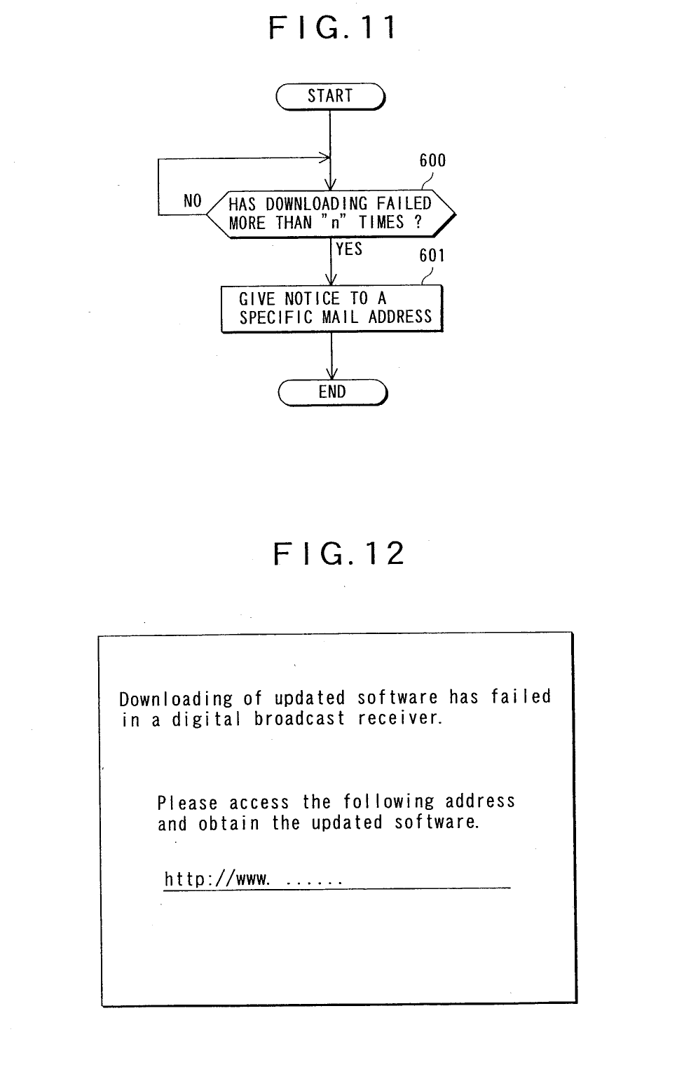

FIG. 11 shows a flowchart of the operation of the receiver 100 in cases where notice of the failure in downloading is given by sending an e-mail.

The informing processor 30 determines whether or not the downloading operation performed by the downloading processor 24 has failed more that “n” times (for example, five times) (step 600). If the number of the failure-times of the downloading is less than “n”, a negative determination is made, and the determination processing in step 600 is repeated.

If the number of the failure-times of the downloading operation reaches “n”, an affirmative determination is made in step 600. Then the informing processor 30 gives notice to a specific e-mail address of the downloading failure (step 601). The specific e-mail address is, for example, an e-mail address used for the driver to send and receive e-mail through the use of a personal computer disposed in the driver's or user's house. The informing processor 30 generates the e-mail (which will be described later in more detail) including predetermined contents, and sends the e-mail to the specific e-mail address via the mobile telephone 700 connected to the receiver 100, thereby giving notice of the downloading failure.

FIG. 12 shows an exemplary e-mail sent by the informing processor 30. As shown in FIG. 12, the e-mail generated by the informing processor 30 includes the following contents: (1) notice that the downloading of the software has ended in failure,(2) message that suggests the acquisition of the software over the Internet, and (3) the specific address of a website that distributes the software on the Internet.

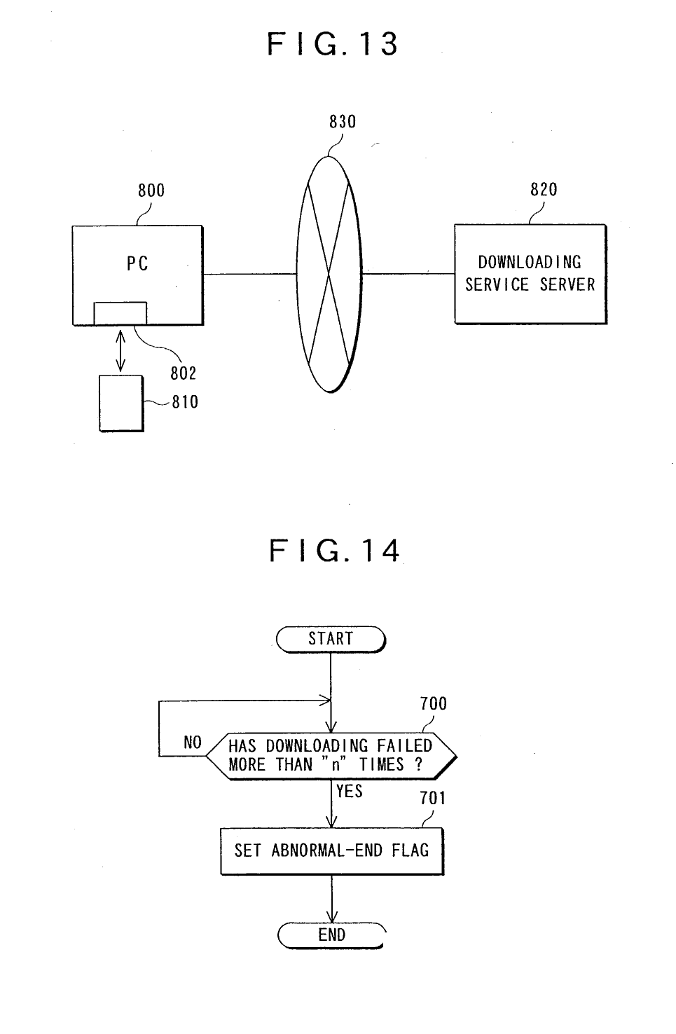

FIG. 13 is a schematic diagram showing a method in which the user obtains the software by means of the personal computer and the like disposed in the user's house. Referring now to FIG. 13, the personal computer (PC) 800 is disposed in, for example, the user's house, and has a slot 802 for holding the memory card 810 so as to input and output the data. The downloading service server 820 is used to manage on the Internet the website providing the software to be installed by the receiver 100. Between the personal computer 800 and the downloading service server 820 is connected a predetermined network 830. The network 830 of the embodiment includes various networks such as a general telephone network, a mobile telephone network, or the Internet.

Based on an operating instruction provided by the user, the personal computer 800 accesses the downloading service server 820 to download the updated software via the network 830. The downloaded software is transferred to the memory card 810 via the slot 802. After the memory card 810 with the software stored therein is inserted in the slot 9 disposed in the receiver 100, the downloading processor 24 reads out the updated software stored in the memory card 810, thereby loading the software to update it.

As described above, when the acquisition of the updated software by downloading through the use of the broadcast wave ends in failure, the e-mail is sent as to give notice of not only the failure, but also the address for acquisition of the updated software. This enables the user receiving the notice to obtain the updated software at an arbitrary timing, thereby increasing the opportunity to update the software.

### EXAMPLE 7

In the foregoing explanation, the method achieved by the use of the e-mail has been described as one example of a method for obtaining the updated software, other than that achieved by transmitting the broadcast wave. In recent vehicles, the navigation device 200 is often installed as shown in FIG. 1. Now, one example will be described in which this navigation device 200 guides the vehicle to a place where the updated software is available.

FIG. 14 shows a flowchart of the operation of the receiver 100 in cases where the downloading has failed more than a predetermined number of times while the vehicle is parked.

The downloading processor 24 determines whether or not the downloading has failed more than “n” times (for example, five times) (step 700). If the number of the downloading failure-times is less than “n”, a negative determination is made, and the determination processing in step 700 is performed repeatedly. If the number of the downloading failure-times reaches “n”, an affirmative determination is made in step 700. Next, the downloading processor 24 sets the abnormal-end flag indicating that the downloading operation executed “n” times has not normally terminated (step 701).

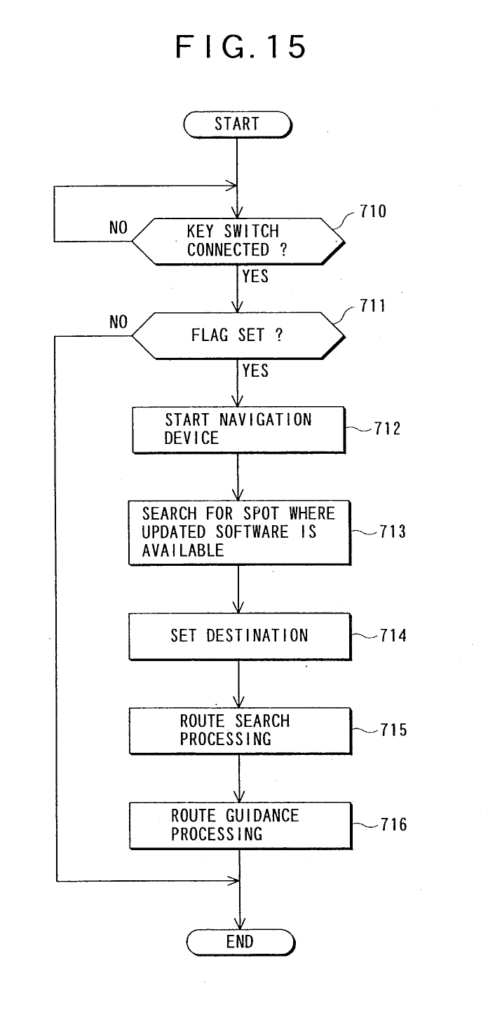

FIG. 15 is a flowchart of the operation of the receiver 100 and the navigation device 200 when performing route guidance to a place where the software is available.

The key-state detector 28 determines whether the key switch is turned on or not (step 710). If not, a negative determination is made, and the determination processing in step 710 is performed repeatedly. When the driver operates the ignition key to turn on the key switch, an affirmative determination is made in step 710. Then the downloading processor 24 determines whether the abnormal-end flag has been set or not (step 711). If the abnormal-end flag is set in step 701 of FIG. 14, an affirmative determination is made in step 711. Then the downloading processor 24 sends a predetermined start-up instruction to start up the navigation device 200 (step 712).

In response to this start-up instruction, the navigation device 200 is started up, and the destination setter 72 of the navigation controller 50 searches for a place (hereinafter, referred to as “updated-software available place”) where the updated software is available (step 713). The resulting updated-software available place is set as a destination for the route search (step 714). It is noted that if a plurality of resulting updated-software available places is extracted, one place selected from them by the user, or the nearest one to the present vehicle position, may be set as the destination.

With the destination set, the route search processor 74 performs predetermined route search processing that searches for a guidance route connecting the set destination and the present vehicle position at an optimum cost (step 715). After the guidance route is found, the route guidance processor 78 performs. the route guidance processing along the resulting guidance route (step 716). Thereafter, when the vehicle reaches the updated-software available place, the user can obtain the software by the use of the memory card 810 in the facility located at the place.

Thus, when the downloading through the use of the broadcast wave fails to obtain the updated software, the vehicle is guided to a place where the updated software is available. This guidance enables the acquisition of the updated-software by driving the vehicle, thereby increasing the opportunity to update the software.

Therefore, it is understood that the invention is not to be limited to the specific embodiments disclosed, and that modifications of the embodiments are intended to be included within the scope of the invention. For example, in the described embodiment, when the downloading of an updated software by using the broadcast wave ends in failure, the software is obtained from the downloading service server 820 through a personal computer 800 to be transferred to the receiver 100 by means of the memory card 810. The present invention, however, is not limited to this case. For example, the receiver 100 may directly access the downloading service server 820 by the use of the mobile telephone 700 to obtain the software.

Instead of the personal computer 800, the software may be obtained from the downloading service server 820 by utilizing a mobile telephone having an Internet connecting function, to be transferred from the mobile telephone to the receiver 100. In this case, if the mobile telephone is capable of holding the memory card, the software may be stored in the memory card, and then this memory card may be inserted in the slot 9 of the receiver 100, thereby transferring the software. Alternatively, a mobile telephone having a wireless communications function such as Bluetooth may be utilized, and the receiver 100 may be provided with a wireless communications function, thereby transferring the software through wireless communications.

As can be seen from the above-mentioned description, according to one aspect of the present invention, when the reception state of the broadcast wave is bad while the vehicle is parked, and thus the execution of the downloading operation is not expected to normally end at such a parking place, the receiver is prevented from executing the downloading operation. This minimizes power consumption which may be caused by performing the undesired downloading operation, thereby preventing battery exhaustion.

Further, according to another aspect of the present invention, if another vehicle-mounted device is selected, the downloading operation is carried out. Therefore, even in a vehicle frequently used in the middle of the night, which is likely to be designated as the time for the scheduled downloading, , this increases the opportunity to update the software by the downloading.

Further, according to still another aspect of the present invention, even when the vehicle receiver is selected, the downloading operation is forcefully executed in compliance with the scheduling, thereby increasing the opportunity to download the software as much as possible. Moreover, in cases where viewing or listening to the programs through the receiver is interrupted by the downloading operation, switching to the other vehicle-mounted device is performed so that sounds can be listened to or pictures can be viewed from the other vehicle-mounted device, thereby reducing wasteful spare time during the downloading operation.

Further, according to a further aspect of the present invention, when the downloading by the use of the broadcast wave fails to obtain the updated software, a notice of the failure is given by e-mail. This notice allows a driver or the like receiving it to prepare for the next downloading operation in response to the next scheduling and to take measures, for example planning acquisition of the software by other ways, thereby increasing the opportunity to update the software.

In addition, according to a further aspect of the present invention, when the downloading by the use of the broadcast wave fails to obtain the updated software, the vehicle can be guided to a place where the updated software is available by the use of the navigation device mounted in the vehicle. The updated software is available to the driver without performing the downloading by using the broadcast wave, thus increasing the opportunity to update the software.

What is claimed is:

1. A vehicle receiver that downloads software by utilizing a broadcast wave, wherein the vehicle receiver is prevented from performing downloading if said receiver is not in a good reception state of said broadcast wave when the vehicle is parked.

2. The vehicle receiver according to claim 1, further comprising:
a downloading processor for executing the downloading operation;
a scheduling processor for scheduling the downloading operation such that said downloading processor executes the downloading operation at a predetermined time;
a reception-state determining section for determining the reception state of the broadcast wave;
a first downloading setter operable to set the downloading operation of said downloading processor to a non-execution state if said receiver is determined not to be in the good reception state when the vehicle is parked; and
a standby processor operable to set a component of the receiver which is required for reception of the broadcast wave to be in a standby state after the setting of said first downloading setter.

3. The vehicle receiver according to claim 2, further comprising a key-state detector for detecting connection and disconnection states of a key switch of the vehicle,
wherein, when said key-state detector detects the disconnection of the key switch, said first downloading setter performs the setting operation of the non-execution state based on the reception state determined by said reception-state determining section.

4. The vehicle receiver according to claim 3, wherein said reception-state determining section determines the reception state based on a reception level of an intermediate frequency signal corresponding to said broadcast wave.

5. The vehicle receiver according to claim 3, wherein said reception-state determining section determines the reception state based on a bit error rate occurring after demodulation of data on said broadcast wave.

6. The vehicle receiver according to claim 3, further comprising a first informing section for giving a predetermined notice of when the first downloading setter sets the downloading operation to the non-execution state.

7. The vehicle receiver according to claim 3, further comprising a second downloading setter operable to set the downloading operation of said downloading processor to the non-execution state in a case where the downloading operation is executed unsuccessfully by said downloading processor.

8. The vehicle receiver according to claim 7, wherein said second downloading setter performs the setting of said non-execution state based on the downloading operation being executed unsuccessfully a predetermined plurality of times by said downloading processor.

9. The vehicle receiver according to claim 8, further comprising a second informing section for providing a predetermined notice when the second downloading setter sets the downloading operation to the non-execution state.

10. The vehicle receiver according to claim 9, further comprising a flag setter for setting a predetermined abnormal-end flag when the downloading operation is set to the non-execution state by said second downloading setter,
wherein said second informing section provides the notice when said abnormal-end flag is set with the receiver started up.

11. A vehicle receiver that downloads software by utilizing a broadcast wave, wherein at least one other vehicle-mounted device and said vehicle receiver are switchably selected as an output source, and when one of said other vehicle-mounted devices is selected, the downloading operation is rendered valid.

12. The vehicle receiver according to claim 11, further comprising:
a downloading processor for executing the downloading operation;
a scheduling processor for scheduling the downloading operation such that said downloading processor executes the downloading operation at a predetermined time;
a selected-state determining section for determining which of said vehicle receiver and said other vehicle-mounted device is in a selected state; and
a third downloading setter operable to set the downloading operation of said downloading processor valid when said other vehicle-mounted device is determined to be in the selected state by said selected-state determining section.

13. The vehicle receiver according to claim 12, wherein, when switching to said vehicle receiver during the downloading operation, said downloading operation takes priority.

14. The vehicle receiver according to claim 12, further comprising a third informing section for providing notice that the downloading is being executed when switching to said vehicle receiver during the downloading operation.

15. The vehicle receiver according to claim 14, wherein said downloading processor stops the downloading operation when switching to the vehicle receiver is instructed again after being given the notice by said third informing section.

16. A vehicle receiver that downloads software by utilizing a broadcast wave, wherein at least one other vehicle-mounted device and said vehicle receiver are switchably selected as an output source, a downloading operation is accepted with the vehicle receiver selected, and the vehicle receiver is switched to another vehicle-mounted device as a selection when said downloading operation starts.

17. The vehicle receiver according to claim 16, comprising:
a downloading processor for executing the downloading operation;
a scheduling processor for scheduling the downloading operation such that said downloading processor executes the downloading operation at a predetermined time;
a fourth downloading setter operable to make the downloading operation of said downloading processor valid when the vehicle receiver is in a selected state; and
a switchover instructing section operable to provide an instruction to switch from the vehicle receiver to said another vehicle-mounted device as the selection when the downloading operation starts with the vehicle receiver selected.

18. The vehicle receiver according to claim 17, wherein said switchover instructing section provides an instruction to switch from said another vehicle-mounted device to the vehicle receiver as the selection after the downloading operation is terminated.

19. A vehicle receiver that downloads software by utilizing a broadcast wave, wherein, if the downloading operation is executed a predetermined number of times, but not terminated normally, then notice of failure is given by sending an e-mail.

20. The vehicle receiver according to claim 19, comprising:
a downloading processor for executing the downloading operation;
a scheduling processor for scheduling the downloading operation such that the downloading processor executes the downloading operation at a predetermined time; and
a fourth informing section for providing notice of the failure by sending the e-mail when the downloading operation executed a predetermined number of times by the downloading processor is not terminated normally.

21. The vehicle receiver according to claim 20, wherein said e-mail sent by said fourth informing section includes a notice that said downloading operation was not terminated normally and a specific address where the updated software is available.

22. The vehicle receiver according to claim 21, further comprising an updated-software transferring section for transferring to the vehicle receiver said updated software obtained at said specific address included in the e-mail.

23. The vehicle receiver according to claim 22, wherein said updated-software transferring section includes a recording medium in which the updated software is recorded, and a readout section for reading the updated software from said recording medium.

24. A vehicle-mounted system comprising a vehicle receiver for downloading software by utilizing a broadcast wave and a navigation device having functions of route search and route guidance,
wherein, when the downloading operation in the vehicle receiver is executed a predetermined number of times unsuccessfully, said vehicle receiver requests said navigation device to perform route guidance to a place where the updated software is available.

25. The vehicle-mounted system according to claim 24, said vehicle receiver comprising:
a downloading processor for executing the downloading operation;
a scheduling processor for scheduling the downloading operation such that said downloading processor executes the downloading operation at a predetermined time; and
a request section operable to make a request to said navigation device for said route guidance when the downloading operation is executed a predetermined number of times by said downloading processor unsuccessfully.

26. The vehicle-mounted system according to claim 25, said navigation device comprising:
a destination setter operable to set the place where the updated software is available as a destination for route search processing when the route guidance is requested;
a route search processor for performing the route search processing so as to search for a traveling route for guiding a vehicle to the destination set by said destination setter; and
a route guidance processor for guiding the vehicle to the destination along the traveling route obtained by the route search processing of said route search processor.
